(19) United States
(12) Patent Application Publication
(10) Pub. No.: US 2024/0238707 A1
(43) Pub. Date: Jul. 18, 2024

(54) WATER FILTER ELEMENT HAVING A REMOVAL AND REPLACEMENT MEMBER

(71) Applicant: Qingdao Ecopure Filter Co., Ltd., Qingdao (CN)

(72) Inventor: Zhibin Zou, Qingdao (CN)

(73) Assignee: Qingdao Ecopure Filter Co., Ltd., Qingdao (CN)

(21) Appl. No.: 18/496,275

(22) Filed: Oct. 27, 2023

(30) Foreign Application Priority Data
Jan. 16, 2023 (CN) 202310066080.X
Jan. 16, 2023 (CN) 202320140590.2

(51) Int. Cl. B01D 35/30

(52) U.S. Cl. CPC B01D 35/30; B01D 2201/305; B01D 2201/306

(57) ABSTRACT

A water filter element for use within a water purification system includes a housing, a locking protrusion, and a handle. The housing comprises a first end comprising a water inlet and a water outlet and a second end opposite the first end. The locking protrusion is positioned on the housing proximate the second end of the housing, and the handle is disposed on the second end of the housing. The handle comprises an outer side oriented away from the first end of the housing. When the water filter element is installed within the water purification system, the outer side of the handle causes the second end of the housing to be radially displaced such that the locking protrusion is engaged by a lock of the water purification system. Water filter assemblies including the water filter element and methods of installing and removing the water filter element are also described.

### CROSS-REFERENCE TO RELATED APPLICATIONS

This application claims priority to Chinese Patent Application No. 202310066080.X, filed Jan. 16, 2023, and Chinese Patent Application No. 202320140590.2, filed Jan. 16, 2023, each of which is hereby incorporated by reference in its entirety.

### BACKGROUND

Water filter elements are known in the art for use in refrigeration units, fountains, and the like in order to reduce solid particles and debris from circulating in water. Water filter elements are typically placed in-line within the fountain circulation system and house a liquid-permeable filter media such that, during operation of the circulation system, the water flows through the filter media and is pumped out of the fountain, while debris is captured on the filter media for later removal.

Many modern refrigerators and fountains have been developed to produce filtered water through water dispenser features due to high demand. Water from a plumbed water line may flow through a water filter before being dispensed. Though water filters are widely used, that the water filter elements have a limited lifespan, and therefore need to be replaced periodically.

Several different variations of removable water filter designs have been developed, most of which require the steps of opening a water filter compartment cover, removing and replacing the water filter element, and closing the water filter compartment cover. Water filter compartment covers are known to come in different configurations. Various covers may comprise pushbuttons, hinged clasps, screws, or other fasteners.

### SUMMARY

The following is a brief summary of subject matter that is described in greater detail herein. This summary is not intended to be limiting as to the scope of the claims.

In a first aspect, a water filter element for use within a water purification system, comprises a housing, a locking protrusion, and a handle. The housing comprises a first end comprising a water inlet and a water outlet and a second end opposite the first end. The locking protrusion is positioned on the housing proximate the second end of the housing, and the handle is disposed on the second end of the housing. The handle comprises an outer side oriented away from the first end of the housing. When the water filter element is installed within the water purification system, the outer side of the handle causes the second end of the housing to be radially displaced such that the locking protrusion is engaged by a lock of the water purification system.

In a second aspect, a water filter element includes the water filter element of the previous aspect, wherein the handle has an oblique tapered surface.

In a third aspect, a water filter element includes the water filter element of the first aspect, wherein the outer side of the handle comprises a beveled surface or a curved surface.

In a fourth aspect, a water filter element includes the water filter element of any of the previous aspects, wherein the locking protrusion comprises a beveled surface or a curved surface.

In a fifth aspect, a water filter element includes the water filter element of any of the previous aspects, wherein the handle comprises an open annular interior.

In a sixth aspect, a water filter element includes the water filter element of any of the previous aspects, wherein a guide protrusion is provided on a side of the filter element housing opposite the locking protrusion.

In a seventh aspect, a water filter element includes the water filter element of the seventh aspect, wherein the guide protrusion comprises a beveled or arced surface proximate the first end and a shear surface proximate the second end.

According to an eighth aspect, a water filter assembly includes a water filter compartment, the water filter element of any of the previous aspects, a lock positioned within the water filter compartment, and a water filter compartment cover. The water filter compartment includes an opening at a first end of the water filter compartment and a water system interface at a second end of the water filter compartment. The water system interface is in fluid communication with a water flow path. The lock is configured to engage with the locking protrusion of the water filter compartment. The water filter compartment cover is configured to cover the opening of the water filter compartment, and comprises a guide structure disposed on an inner surface thereof. When the water filter element is installed in the water filter compartment, the locking protrusion on the water filter element faces the lock within the water filter compartment and the guide structure abuts the handle, thereby radially displacing the second end of the water filter element such that the locking protrusion engages with the lock.

According to a ninth aspect, the water filter assembly includes the water filter assembly of the eighth aspect, wherein the guide structure has a convex shape.

According to a tenth aspect, the water filter assembly includes the water filter assembly of the eighth or ninth aspects, wherein guide structure comprises a smooth, curved surface.

According to an eleventh aspect, the water filter assembly includes the water filter assembly of any of the eighth through tenth aspects, wherein the outer side of the handle of the water filter element is beveled or curved.

According to a twelfth aspect, the water filter assembly includes the water filter assembly of any of the eighth through eleventh aspects, wherein a guide protrusion is provided on a side of the filter element housing opposite the locking protrusion, and a guide rail is disposed in the water filter chamber opposite the locking structure. When the water filter element is installed in the water filter chamber, the guide protrusion on the filter element housing moves axially along the guide rail in the water filter compartment.

In a thirteenth aspect, a method for installing a water filter element in water purification equipment comprises: opening a water filter compartment cover of a water filter compartment; loading the water filter element into the water filter compartment such that a locking protrusion disposed on a housing of the water filter element is oriented towards a lock disposed within the water filter compartment; and closing the cover of the water filter compartment, wherein a guide structure provided on the water filter compartment cover contacts a handle of the water filter element causing radial displacement of the water filter element until locking protrusion engaged with the lock.

According to a fourteenth aspect, the method comprises the method of the thirteenth aspect, wherein the guide structure has a convex shape.

According to a fifteenth aspect, the method comprises the method of the thirteenth or fourteenth aspects, wherein the guide structure comprises a smooth, curved surface.

According to a sixteenth aspect, the method comprises the method of any of the thirteenth through fifteenth aspects, wherein the handle has an oblique tapered surface.

According to a seventeenth aspect, the method comprises the method of any of the thirteenth through sixteenth aspects, wherein the outer side of the handle of the filter element is beveled or curved.

According to an eighteenth aspect, the method comprises the method of any of the thirteenth through seventeenth aspects, wherein the outer side of the handle slides along the guide structure when the water filter compartment cover is closed, thereby radially displacing the water filter element within the water filter compartment.

According to a nineteenth aspect, the method comprises the method of any of the thirteenth through eighteenth aspects, wherein the water filter compartment further comprises a water system interface at an end, the water filter element comprises a water inlet and a water outlet at an end of the water filter element opposite the handle, and loading the water filter element into the water filter compartment comprises coupling the water inlet and the water outlet to the water system interface of the water filter compartment.

In a twentieth aspect, a method for removing a filter element from water purification equipment comprises the steps of: opening a water filter compartment cover, thereby permitting access to an opening of a water filter compartment; and pulling a handle of the water filter element, thereby removing the water filter element from the water filter compartment through the opening. The opening of the water filter compartment cover is effective to radially displace the water filter element within the water filter compartment and disengage a locking protrusion on the water filter element from a lock within the water filter compartment.

According to a twenty-first aspect, the method comprises the method of the any of the thirteenth through twentieth aspects, wherein the water filter compartment cover is hingedly coupled to an axial end of the water filter compartment.

According to a twenty-second aspect, the method comprises the method of any of the twentieth through twenty-first aspects, wherein the water filter compartment cover is coupled to a lever which comprising a tooth configured to push the water filter element in a radial direction as the water filter compartment cover is opened.

According to a twenty-third aspect, the method comprises the method of the twenty-second aspect, wherein the guide structure has a convex shape and protrudes outwardly from an inner surface of the water filter compartment cover.

### BRIEF SUMMARY OF THE DRAWINGS

The general inventive concepts, as well as illustrative embodiments and advantages thereof, are described below in greater detail, by way of example, with reference to the drawings in which:

FIG. 1 illustrates a front/right/top perspective view of an example water filter element according to one or more embodiments shown and described herein;

FIG. 2 illustrates a rear/left/bottom perspective view of an example water filter element according to one or more embodiments shown and described herein;

FIG. 3 illustrates a rear/left/bottom perspective view of another example water filter element according to one or more embodiments shown and described herein;

FIG. 4 is an illustration of an example water filter compartment including a water filter element in a closed configuration according to one or more embodiments shown and described herein;

FIG. 5 is an illustration of the water filter compartment of FIG. 3 in a partially open configuration according to one or more embodiments shown and described herein;

FIG. 6 is an illustration of the water filter compartment of FIG. 4 and FIG. 5 in a fully open configuration according to one or more embodiments shown and described herein;

FIG. 7 is a close up view of the locking features of the example water filter element shown in FIG. 4;

FIG. 8 is an illustration of another example water filter compartment including a water filter element in a closed configuration according to one or more embodiments shown and described herein;

FIG. 9 is an illustration of the water filter compartment of FIG. 8 in a partially open configuration according to one or more embodiments shown and described herein;

FIG. 10 is an illustration of the water filter compartment of FIG. 8 and FIG. 9 in a fully open configuration according to one or more embodiments shown and described herein;

FIG. 11 is an illustration of an example water filter compartment without a water filter element positioned therein;

FIG. 12 is a flow diagram describing an example method of replacing a filter element according to one or more embodiments shown and described herein; and

FIG. 13 is a flow diagram describing an alternative example method of replacing a filter element according to one or more embodiments shown and described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As used in the specification and the appended claims, the singular forms “a,” “an,” and “the” are intended to include the plural forms as well, unless the context clearly indicates otherwise.

Unless otherwise indicated, any element, property, feature, or combination of elements, properties, and features, may be used in any embodiment disclosed herein, regardless of whether the element, property, feature, or combination was explicitly disclosed in the embodiment. It will be readily understood that features described in relation to any particular aspect described herein may be applicable to other aspects described herein provided the features are compatible with that aspect. In particular, features described herein in relation to the method may be applicable to the filter product and vice versa.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The general inventive concepts relate to water filter elements including features for self-alignment of the water filter element within a water purification system while allowing simple installation and removal by a user. In various embodiments described herein, the water filter element includes a handle that slides along a protrusion disposed on an inner surface of a water filter compartment cover to displace the water filter element within the water filter cavity. The displacement of the water filter element within the water filter cavity enables a lock within the water filter cavity to engage with a locking protrusion on the water filter element, which, in combination with the handle, secure the water filter element in place within the water filter cavity. These and other features will be described in conjunction with various embodiments herein.

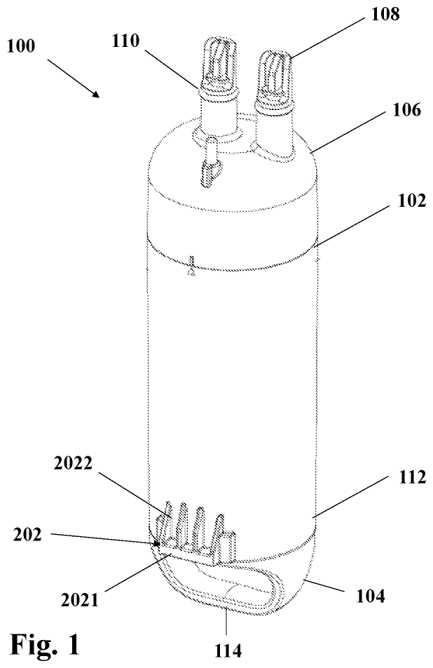

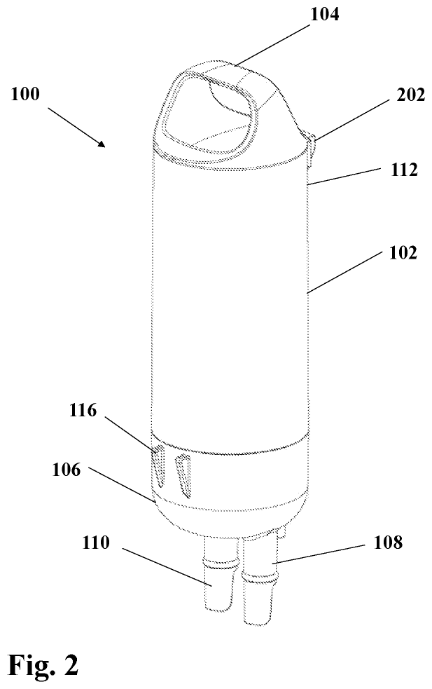

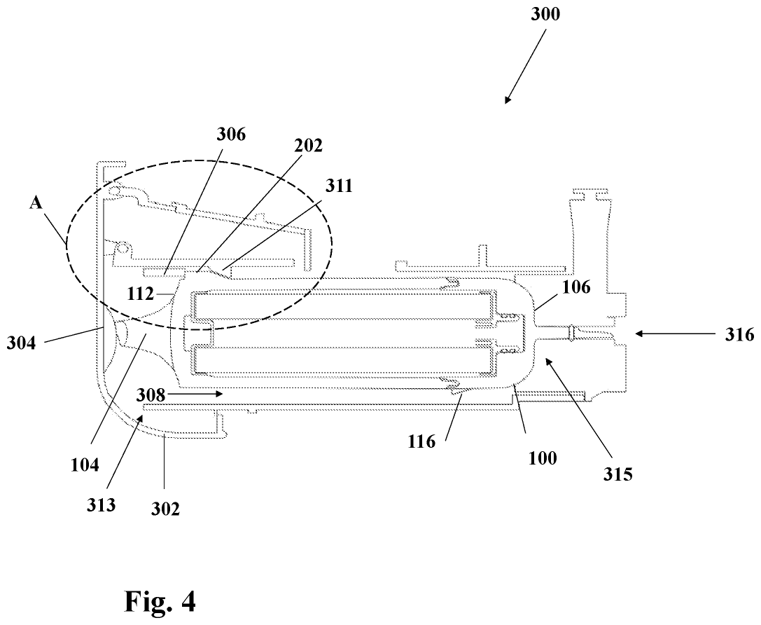

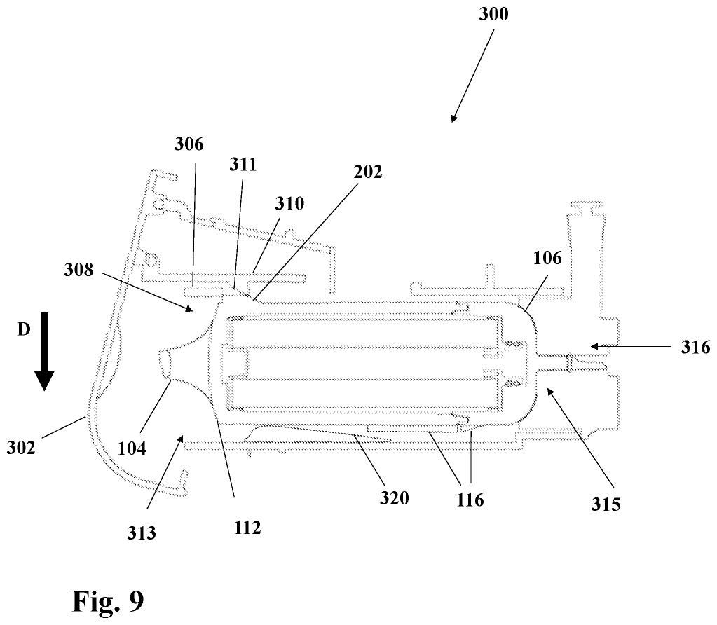

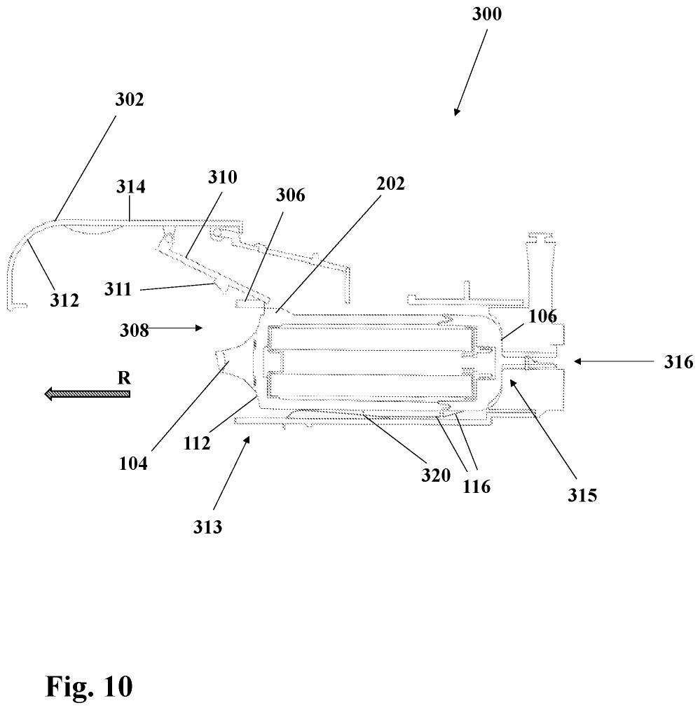

Turning now to FIGS. 1 and 2, an example water filter element 100 is shown. The water filter element 100 generally includes a water filter housing 102 and a pull ring handle 104. The water filter housing 102 is generally cylindrical in shape and has a first end 106 and a second end 112 that generally opposes the first end 106 and is separated from the first end 106 by a length of the water filter housing 102. The water filter housing 102 is an outer peripheral surface of the water filter element 100 that encloses a filter medium (see FIGS. 4-6 and 8-10), which is configured to remove particulates and other contaminants from the water passing through the water filter element.

The first end 106 of the water filter housing 102 includes a water inlet 108 and a water outlet 110. The water inlet 108 and the water outlet 110 are configured to permit the passage of water into and out of the water filter housing 102, as will be described in greater detail below. The pull ring handle 104 is disposed on the second end 112 of the water filter housing 102, and can enable a user to twist, pull, and push the water filter housing during replacement of the water filter element.

The water filter housing 102 can be constructed from a number of different water-resistant materials, including but not limited to, polyethylene (PE), polypropylene (PP), polyvinyl chloride (PVC), or acrylonitrile butadiene styrene (ABS). These materials are readily available, are relatively inexpensive, and can be easily processed using injection molding techniques. In various embodiments, the water filter housing 102 is configured as one integral unit. Accordingly, the injection molding process can be both effective and efficient for making the water filter housing 102. In some embodiments, the pull ring handle 104 can be formed separately through a molding or machining operation and subsequently coupled to the water filter housing 102. For example, the pull ring handle 104 can be bonded, welded, or mechanically coupled to the second end 112 of the water filter housing 102.

As shown in FIGS. 1 and 2, the pull ring handle 104 has a generally open annular interior sized to receive an adult hand. In various embodiments, the pull ring handle 104 has an oblique tapered shape. An outer side 114 of the pull ring handle is oriented away from the first end 106 of the water filter housing 102. As will be described in greater detail below, the outer side of the pull ring handle is configured to contact a guide structure within a water filter compartment of the refrigerator to displace the water filter element 100 within the water filter compartment.

A locking protrusion 202 is positioned on the water filter housing 102 proximate to or near the second end 112 of the water filter housing 102. The locking protrusion 202 includes at least one raised surface, which can be beveled (as shown in the Figures) or curved, depending on the particular embodiment. Although a single locking protrusion 202 is depicted in the figures, it is contemplated that in some embodiments, more than one locking protrusion 202 can be included on the water filter housing 102. When multiple locking protrusions 202 are included, each locking protrusion can be the same as the other locking protrusions, or the locking protrusions can be different from one or more other locking protrusions. As shown in FIGS. 1 and 2, the locking protrusion 202 is saw-tooth shaped with a shear edge 2021 and a sloped edge 2022. The sloped edge 2022 allows the water filter to abut a complimentary shaped surface while the shear edge 2021 locks the filter into position in the filter cavity (e.g., the water filter compartment) of the refrigerator.

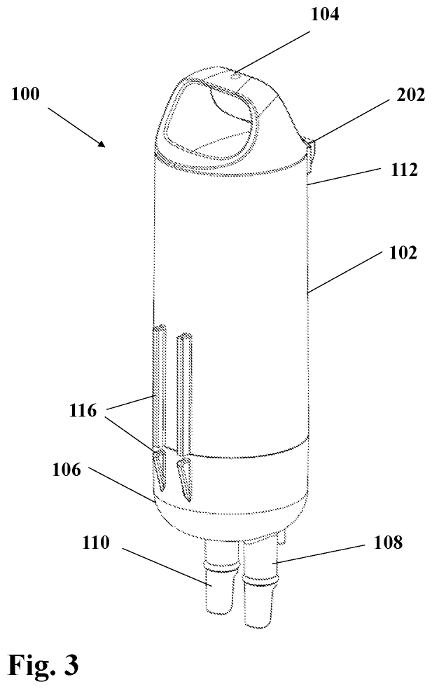

In some embodiments, the water filter housing 102 is provided with a guide protrusion 116, which is positioned close to or at the first end 106 of the water filter housing 102. The guide protrusion 116 is provided on a side of the water filter housing 102 opposite the locking protrusion 202. In embodiments, the guide protrusion 116 is located at a position along the water filter housing 102 that is approximately centrally symmetric about the central axis of the water filter housing 102 with respect to a position of the locking protrusion 202 along the water filter housing 102. In some embodiments, the guide protrusion 116 is in a zigzag or triangular shape, with a beveled or arced surface of the guide protrusion 116 proximate the first end 106 of the water filter housing 102, and a shear surface of the guide protrusion 116 proximate the second end 112 of the water filter housing 102, as shown in FIG. 2. In other embodiments, the guide protrusion 116 can also be designed as a flat surface in other shapes. As shown in FIG. 2, in some embodiments, the water filter housing 102 includes two guide protrusions 116 arranged adjacent to one another. The guide protrusions 116 enable the water filter element 100 to cooperate with the guide rails of complementary shapes to guide the water filter element 100 into the water filter compartment of the refrigerator. In some embodiments, the water filter housing 102 may include additional guide protrusions 116, such as elongated guide protrusions 116 extending axially along the middle section of the water filter housing 102, as shown in FIG. 3.

The water filter housing 102 may also include one or more keys, indicia, or markings to identify the water filter element, assist the user with orienting the water filter element for insertion into the filter cavity of the refrigerator, or for indicating to the user or the refrigerator that the water filter element is compatible with the refrigerator. For example, a key may be included on the water filter housing 102 so that the water filter element 100 cannot be inserted at an improper orientation into the water filter cavity of the refrigerator. These and other features are optional and can be included or omitted from various embodiments described herein.

Once the filter has become dirty and is to be removed and replaced, the appliance is shut down and access to the water filter element 100 is gained by opening a cover. The water filter element 100 can then be lifted out of the compartment by simply grasping the pull ring handle 104 and pulling the water filter element 100 from the cavity. The debris trapped by the water filter element 100 during use will be contained within the water filter housing 102.

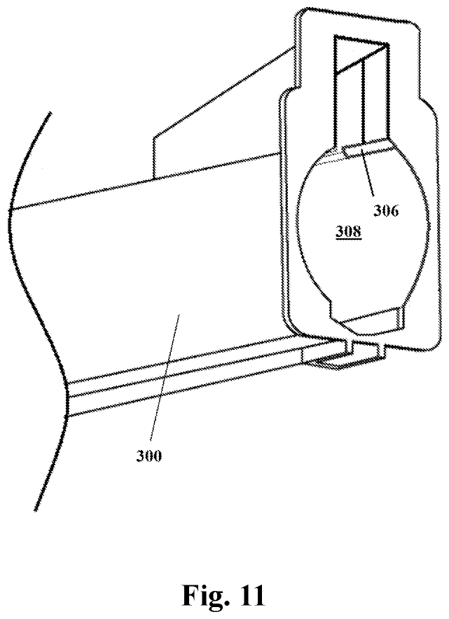

Referring now to FIGS. 4-7, an example water filter compartment 300 is shown including a water filter element 100 positioned therein. FIG. 11 shows the water filter compartment 300 without the water filter element 100 installed inside. The water filter compartment 300 can be positioned within the enclosure of a refrigerator (not shown). For example, the water filter compartment 300 can be positioned in a top corner of the refrigerator, near a center of the refrigerator, or on a door of the refrigerator, as is known in the art. In various embodiments, the water filter compartment 300 is positioned within the enclosure of the refrigerator in a location such that the water filter compartment 300 is out of the way, allowing maximum use of the space within the refrigerator, while remaining generally accessible. In some embodiments, the water filter compartment 300 can be positioned outside of the refrigerator or can be accessible from outside the refrigerator. Moreover, it is contemplated that, in some embodiments, the water filter compartment included in water purification equipment or a water purification system that does not include a refrigerator.

The water filter compartment 300 defines a filter cavity 308, which is configured to receive the water filter element 100. The water filter compartment 300 includes an opening at a first end 313, which allows access to the filter cavity 308, thereby enabling the water filter element 100 to be inserted into the filter cavity 308 of the water filter compartment 300. The second end 315 of the water filter compartment 300 includes a water system interface 316, which is in fluid communication with the water flow path of the water purification equipment (not shown). Accordingly, when the water filter element 100 is fully inserted into the water filter compartment 300, the water inlet 108 and the water outlet 110 of the water filter element 100 are coupled through the water system interface 316 of the water filter compartment 300 to the water flow path of the water purification system to enable water to flow through the water filter element 100 for purification.

As shown in FIGS. 4-7, the water filter compartment 300 further includes a water filter compartment cover 302, which covers the opening and allows selective access to the filter cavity 308. The water filter compartment cover 302 is hingedly coupled to the water filter compartment 300 at an axial end of the water filter compartment, allowing the water filter compartment cover 302 to be rotated with respect to the water filter compartment 300 to expose the opening and permit access to the filter cavity 308. Although depicted FIGS. 4-7 as being hinged at the top of the water filter compartment 300, it is contemplated that the hinge(s) can be positioned along a side or at the bottom of the water filter compartment 300. Moreover, in some embodiments, a clasp, latch, or other securing mechanism (not shown in the figures) can be included to enable the water filter compartment cover 302 to be secured in a closed configuration.

In various embodiments, the water filter compartment cover 302 includes an inner surface 312, which is positioned proximate the water filter compartment 300, and an outer surface 314, which is separated from the water filter compartment 300 by the inner surface 312. The outer surface 314 is exposed to the refrigerator or environment while the water filter compartment cover 302 is in a closed configuration (as shown in FIG. 4). The inner surface 312 of the water filter compartment cover 302 includes a guide structure 304 which guides the water filter element 100 into position within the water filter compartment 300.

In particular, as shown in FIG. 4, the guide structure 304 is configured to contact the outer side of the pull ring handle 104. The guide structure 304 has a generally convex shape and protrudes outwardly from the inner surface 312 of the water filter compartment cover 302. In various embodiments, such as the embodiments shown in FIGS. 4-6, the guide structure 304 is a smooth, curved surface, although it is contemplated that in other embodiments, the guide structure 304 can be beveled, angled, or even a planar protrusion from the inner surface 312 of the water filter compartment cover 302. Regardless of the particular shape of the guide structure 304, the guide structure is configured to displace the water filter element 100, and particularly the second end 112 thereof, within the water filter compartment 300 upon contacting the outer side of the pull ring handle 104. More particularly, in various embodiments, the guide structure 304 abuts the outer side of the pull ring handle 104, which slides along the guide structure 304, thereby displacing the pull ring handle 104 and associated water filter element 100 in a radial direction such that the locking protrusion 202 engages with a corresponding lock 306 within the water filter compartment 300.

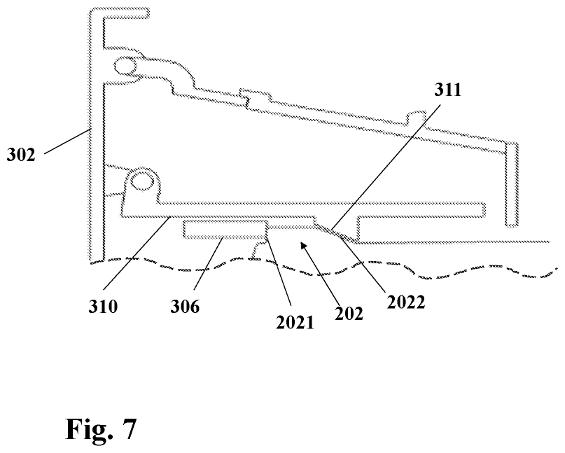

FIG. 7 depicts additional detail within the circle A of FIG. 4. As shown in FIGS. 4-10, the lock 306 is provided on the inner wall of the water filter compartment 300. In some embodiments, the lock 306 is disposed at or near the opening of the water filter compartment 300. The lock 306 is configured to engage the locking protrusion 202 on the water filter element 100, thereby securing the water filter element 100 in place within the water filter compartment 300. To ensure compatibility of the water filter element 100 with the water filter compartment 300 and/or to provide a proprietary arrangement for a selected model or brand, the circumferential position of the locking protrusion 202 about the water filter housing 102 is based on the position of the lock 306 within the water filter compartment 300.

In addition, the water filter compartment cover 302 is coupled to a lever 310 which includes a tooth 311. The lever 310 rotates or pivots as the water filter compartment cover 302 is opened. The pivoting motion of the lever 310 in turn causes the tooth 311 to push the water filter element 100 in a radial direction as the water filter compartment cover is opened, thereby disengaging the water filter element 100 from the lock 306.

FIGS. 4-6 show the water filter compartment cover 302 being opened for replacement of the water filter element 100. In FIG. 4, the water filter compartment 300 is shown in a closed configuration, with the water filter compartment cover 302 preventing access to the water filter compartment 300. The water filter element 100 is installed in the water filter compartment 300, with the water inlet 108 and the water outlet 110 of the water filter element 100 coupled to the water purification system through the water system interface 316 of the water filter compartment 300. The lock 306 is engaged with the locking protrusion 202, and the guide structure 304 abuts the outer surface of the pull ring handle 104, supporting the second end 112 of the water filter element 100 within the water filter compartment 300.

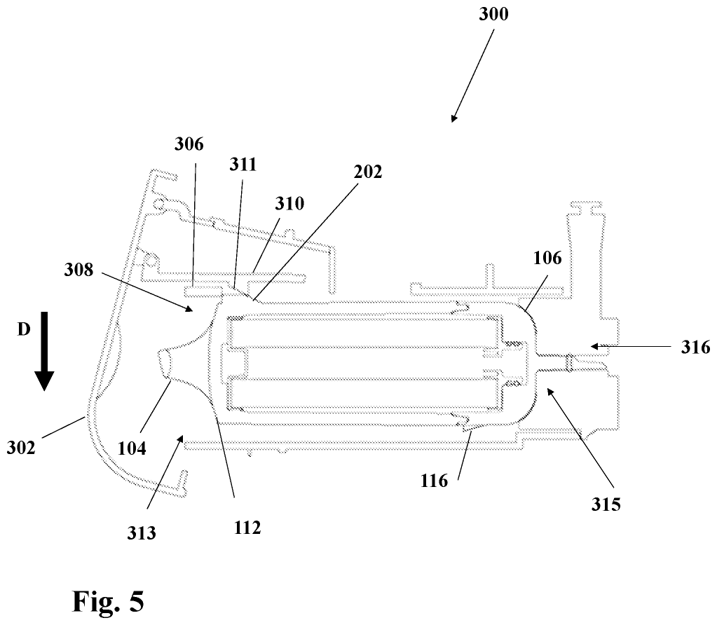

In order to remove the water filter element 100, the user opens the water filter compartment cover 302 by rotating the water filter compartment cover 302 in an upward and outward direction with respect to the water filter compartment 300. In FIG. 5, the water filter compartment 300 is shown in a partially open configuration, such as when the water filter compartment cover 302 is partially opened. The action of opening the water filter compartment cover 302 causes a lever 310 located near the lock 306 to rotate, which in turn causes a tooth 311 on the lever 310 to push the water filter element, and specifically, the tooth 311 on the lever 310 pushes the locking protrusion 202 on the filter element housing, for example, the sloped edge 2022 of the locking protrusion 202, so that the second end 112 of the water filter element 100 moves downward and away from the lock 306 in the direction of arrow D in FIG. 5, thereby disengaging the water filter element 100 from the lock 306. The separation of the water filter element 100 from the upper wall of the water filter compartment 300 allows for a smooth release of the water filter element 100 from the water filter compartment 300.

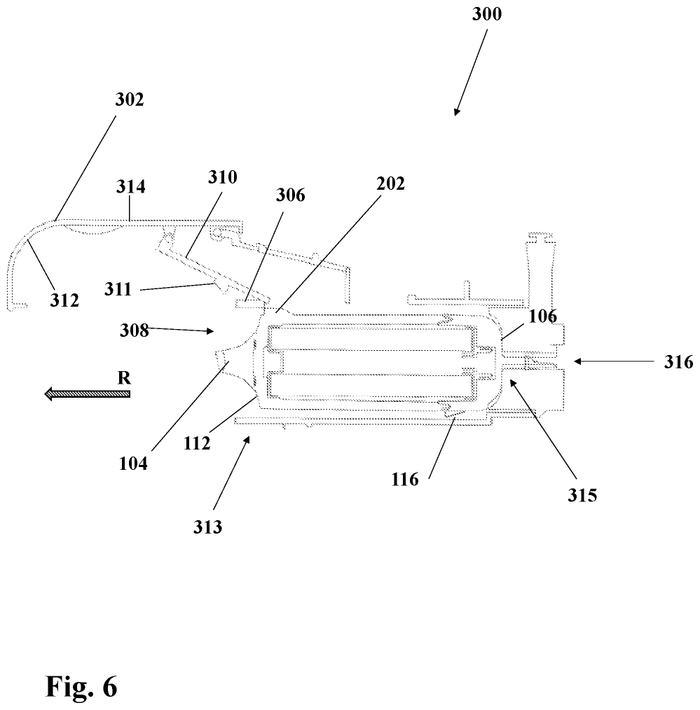

FIG. 6 illustrates the water filter compartment cover 302 in a fully open configuration. In particular, the water filter compartment cover 302 is fully open, and access to the water filter compartment 300 is unobstructed. As shown in FIG. 6, the water filter element 100 is located radially downward relative to its position in FIG. 4. The lock 306 is disengaged from the locking protrusion 202 on the water filter housing 102, and there are no obstructions to an axial removal of the water filter element 100 from the water filter compartment 300. The pull ring handle 104 is now fully accessible to the user for removal of the water filter element 100 from the water filter compartment 300. The user can grasp the water filter element 100 by the pull ring handle 104 and pull the water filter element 100 axially out of the water filter compartment 300, as shown by arrow R.

To insert the water filter element, the user orients the water filter element 100 with the locking protrusion 202 in a direction facing the lock 306 within the water filter compartment 300 and the water inlet 108 and water outlet 110 toward the water filter compartment 300, and inserts the water filter element 100 into the water filter compartment 300. The user pushes the pull ring handle 104 towards the water filter compartment 300 to position the water filter element 100 within the water filter compartment 300 (in a direction opposite arrow R in FIG. 6). Then, as the user closes the water filter compartment cover 302 by rotating the water filter compartment cover 302 down and towards the water filter compartment 300, the guide structure 304 abuts the outer surface of the pull ring handle 104, which slides upward along the guide structure 304, thereby moving the water filter element 100 in a radial and upward direction (opposite the direction of arrow D in FIG. 5). As the water filter element 100 moves upward within the water filter compartment 300, the locking protrusion 202 slides past the lock 306 and engages with the lock 306. With the water filter compartment cover 302 closed, the guide structure 304 secures the pull ring handle 104 in place radially, while the lock 306 secures the water filter element 100 in place axially through the locking protrusion 202.

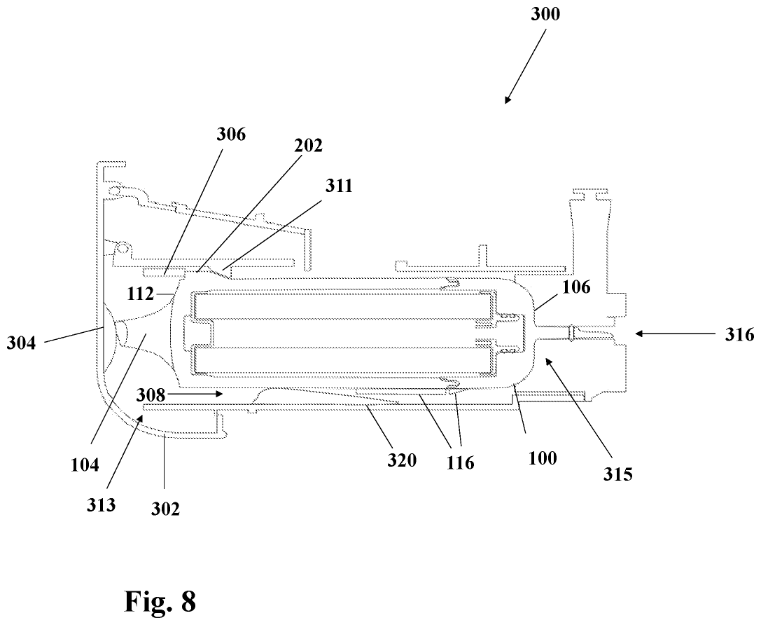

In some embodiments, the inner wall of the water filter compartment 300 is provided with at least one guide rail 320 extending in the axial direction, and the guide rail 320 is arranged in the water filter compartment 300 opposite the locking protrusion 202. As shown in FIGS. 8-10, the guide rail 320 protrudes radially from the inner wall of the water filter compartment 300. When the water filter element 100 is installed in the water filter compartment 300, the highest protruding point of the guide rail 320 contacts the outer wall of the water filter element 100. During the axial movement of the water filter element 100 within the water filter compartment 300, the guide rail 320 and the inner wall of the water filter compartment 300 restrict radial movement of the water filter element 100. In some embodiments, in order to prevent the guide rail 320 from hindering the axial movement of the water filter element 100 within the water filter compartment 300, the guide rail 320 is configured as an elastic piece with sections including varying heights (e.g., high, medium, and low sections), and is positioned close to the opening of the water filter compartment 300. In embodiments, one side of the guide rail 320 is a bevel. In some embodiments, the guide rail 320 is located further inward relative to the lock 306, near the front or the middle of the filter cavity 308. The guide rail 320 is configured to cooperate with the guide protrusion 116 on the water filter element 100 to guide the water filter element 100 into or out of the water filter compartment 300. In order to ensure the compatibility of the water filter element 100 and the water filter compartment 300 and/or provide a special configuration for a selected model or brand, the position of the guide rail 320 in the circumferential direction of the inner wall of the water filter compartment 300 is adapted to the position of the guide protrusion 116. In some embodiments, the guide protrusion 116 on the water filter housing 102 moves axially along the guide rail 320 in the water filter compartment 300. In other embodiments, two adjacent guide protrusions 116 can form a guide groove matching the guide rail 320 with the water filter housing 102 and cooperate with the guide rail of matching shape to guide the water filter element 100 into or out of the water filter compartment 300.

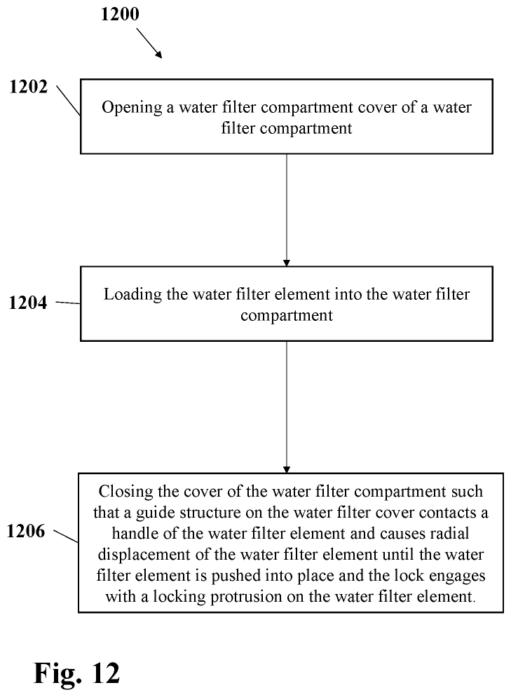

Referring now to FIG. 12, a flow diagram 1200 illustrating an example method for installing a water filter element is shown.

At block 1202, the water filter compartment cover 302 of the water filter compartment 300 is opened.

At block 1204, the water filter element 100 is loaded into the water filter compartment 300.

At block 1206, the water filter compartment cover of the water filter compartment is closed such that a guide structure provided on the water filter compartment cover contacts a handle of the water filter element and causes radial displacement of the water filter element until the water filter element is pushed into place and the lock engages with a locking protrusion on the water filter element (e.g., the shear edge 2021 of the locking protrusion 202).

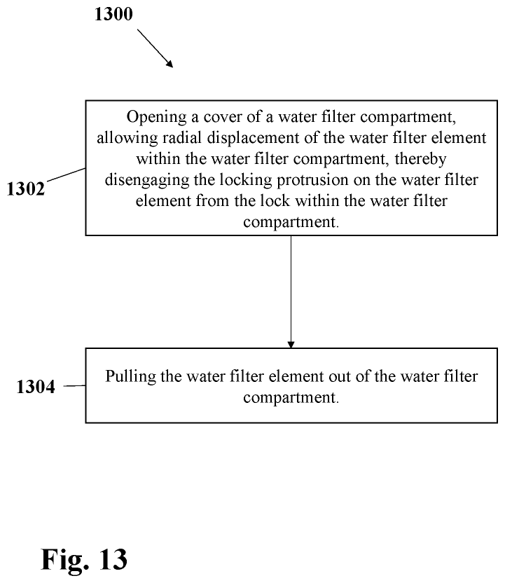

Referring now to FIG. 13, a flow diagram 1300 illustrating an example method for removing a water filter element is shown.

At block 1302, the water filter compartment cover of the water filter compartment is opened, allowing radial displacement of the water filter element within the water filter compartment, thereby disengaging the locking protrusion on the water filter element from the lock within the water filter compartment (e.g., the shear edge 2021 of the locking protrusion 202 is disengaged from the lock 306 in the water filter compartment).

At block 1304, the water filter element is pulled out of the filter element compartment.

The above description includes non-limiting examples of the various embodiments. It is, of course, not possible to describe every conceivable combination of components or methods for purposes of describing the disclosed subject matter, and one skilled in the art may recognize that further combinations and permutations of various embodiments are possible. The disclosed subject matter is intended to embrace all such alterations, modifications, and variations that fall within the spirit and scope of the appended claims.

With regard to the various functions performed by the above described components, the terms (including a reference to a “means”) used to describe such components are intended to also include, unless otherwise indicated, any structure(s) which performs the specified function of the described component (e.g., functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over the other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A water filter element for use within a water purification system, comprising:
a housing comprising:
a first end comprising a water inlet and a water outlet;
a second end opposite the first end,
a locking protrusion positioned on the housing proximate the second end of the housing; and
a handle disposed on the second end of the housing and comprising an outer side oriented away from the first end of the housing;
wherein when the water filter element is installed within the water purification system, the outer side of the handle causes the second end of the housing to be radially displaced such that the locking protrusion is engaged by a lock of the water purification system.

2. The water filter element of claim 1, wherein the handle has an oblique tapered surface.

3. The water filter element according to claim 1, wherein the outer side of the handle comprises a beveled surface or a curved surface.

4. The water filter element of claim 1, wherein the outer side of the handle comprises at least one protrusion.

5. The water filter element of claim 1, wherein the locking protrusion comprises a beveled surface or a curved surface.

6. The water filter element of claim 1, wherein the handle comprises an open annular interior.

7. The water filter element of claim 1, wherein a guide protrusion is provided on a side of the filter element housing opposite the locking protrusion.

8. The water filter element of claim 7, wherein the guide protrusion comprises a beveled or arced surface proximate the first end of the filter element housing and a shear surface proximate the second end of the filter element housing.

9. A water filter assembly, comprising:
a water filter compartment including an opening at a first end of the water filter compartment and a water system interface at a second end of the water filter compartment, wherein the water system interface is in fluid communication with a water flow path;
the water filter element of claim 1;
a lock positioned within the water filter compartment configured to engage with the locking protrusion of the water filter compartment; and
a water filter compartment cover configured to cover the opening of the water filter compartment, the water filter compartment cover comprising a guide structure disposed on an inner surface thereof;
wherein when the water filter element is installed in the water filter compartment, the locking protrusion on the water filter element faces the lock within the water filter compartment and the guide structure abuts the handle, thereby radially displacing the second end of the water filter element such that the locking protrusion engages with the lock.

10. The water filter assembly of claim 9, wherein the guide structure has a convex shape.

11. The water filter assembly of claim 10, wherein the guide structure comprises a smooth, curved surface.

12. The water filter assembly of claim 9, wherein the water filter compartment comprises a guide rail opposite the locking structure, and when the water filter element is installed in the water filter compartment, the guide protrusion on the filter element housing moves axially along the guide rail in the water filter compartment.

13. A method for installing a water filter element in water purification equipment comprising the steps of:
opening a water filter compartment cover of a water filter compartment;
loading the water filter element into the water filter compartment such that a locking protrusion disposed on a housing of the water filter element is oriented towards a lock disposed within the water filter compartment;
closing the cover of the filter element compartment, wherein a guide structure provided on the water filter compartment cover contacts a handle of the water filter element causing radial displacement of the water filter element until locking protrusion engaged with the lock.

14. The method of claim 13, wherein the outer side of the handle of the filter element is beveled or curved.

15. The method of claim 14, wherein the outer side of the handle slides along the guide structure when the water filter compartment cover is closed, thereby radially displacing the water filter element within the water filter compartment.

16. The method of claim 13, wherein the water filter compartment further comprises a water system interface at an end, the water filter element comprises a water inlet and a water outlet at an end of the water filter element opposite the handle, and loading the water filter element into the water filter compartment comprises coupling the water inlet and the water outlet to the water system interface of the water filter compartment.

17. A method for removing a filter element from water purification equipment comprising the steps of:
opening a water filter compartment cover, thereby permitting access to an opening of a water filter compartment; and
pulling a handle of the water filter element, thereby removing the water filter element from the water filter compartment through the opening,
wherein the opening the water filter compartment cover is effective to radially displace the water filter element within the water filter compartment and disengage a locking protrusion on the water filter element from a lock within the water filter compartment.

18. The method of claim 17, wherein the water filter compartment cover is hingedly coupled to an axial end of the water filter compartment.

19. The method of claim 17, wherein the water filter compartment cover is coupled to a lever comprising a tooth configured to push the water filter element in a radial direction as the water filter compartment cover is opened.

20. The method of claim 19, wherein the guide structure has a convex shape and protrudes outwardly from an inner surface of the water filter compartment cover.
